(19) United States
(12) Patent Application Publication
(10) Pub. No.: US 2013/0243369 A1
(43) Pub. Date: Sep. 19, 2013

(54) OPTICAL SWITCH DEVICE AND METHODS OF MANUFACTURING THE SAME

(71) Applicants: Sang Ho PARK, Daejeon (KR); Jang Uk Shin, Daejeon (KR); Young-Tak Han, Daejeon (KR); Yongsoon Baek, Daejeon (KR)

(72) Inventors: Sang Ho PARK, Daejeon (KR); Jang Uk Shin, Daejeon (KR); Young-Tak Han, Daejeon (KR); Yongsoon Baek, Daejeon (KR)

(73) Assignee: ELECTRONICS AND TELECOMMUNICATIONS RESEARCH INSTITUTE, Daejeon (KR)

(21) Appl. No.: 13/606,218

(22) Filed: Sep. 7, 2012

(30) Foreign Application Priority Data
Mar. 14, 2012 (KR) 10-2012-0026264

(51) Int. Cl. G02B 6/12; B44C 1/22; B05D 5/06

(52) U.S. Cl. 385/14; 427/97.4; 216/13

(57) ABSTRACT

The inventive concept provides optical switch devices and methods of manufacturing the same. The optical switch device may include a substrate including a first region and a second region, a first multi-mode optical waveguide disposed on the substrate of the first region, an electrode wire disposed on the substrate of the second region, a heater disposed on a top surface of the first multi-mode optical waveguide, and connection wires connecting the heater to the electrode wire. The first multi-mode optical waveguide may have incline sidewalls, and the connection wires may be disposed on the incline sidewalls of the first multi-mode optical waveguide.

### CROSS-REFERENCE TO RELATED APPLICATIONS

This U.S. non-provisional patent application claims priority under 35 U.S.C. §119 to Korean Patent Application No. 10-2012-0026264, filed on Mar. 14, 2012, the entirety of which is incorporated by reference herein.

### BACKGROUND

The inventive concept relates to optical switch devices and methods of manufacturing the same and, more particularly, to total-reflection type optical switch device and methods of manufacturing the same.

Recently, high capacity, high speed, and/or high function of optical communication systems have been increasingly demanded in an optical communication industry. For example, the optical communication systems may includes a wavelength division multiplexing (WDM) optical communication system and a reconfigurable optical add-drop multiplexing (ROADM) optical communication system. The ROADM optical communication system may connect a plurality of channels simultaneously. Thus, utilization of a network may be improved. Additionally, cost of the optical communication system may be reduced and a network structure may be simplified.

Optical switches may be important components in the optical communication systems. The optical switch may be an optical device controlling a path of an optical signal externally. For example, the path of the optical signal passing through the optical switch may be changed or not changed by a total-reflection effect. In other words, the optical signal may be switched using the optical signal path change caused by the total-reflection effect.

However, the optical communication systems may demand optical switches having various functions with the development of the optical communication industry. Thus, researches have been conducted for optical switches performing new functions.

### SUMMARY

Embodiments of the inventive concept may provide optical switch devices with improved reliability.

Embodiments of the inventive concept may also provide methods of manufacturing an optical switch device with improved reliability.

In one aspect, an optical switch device may include: a substrate including a first region and a second region; a first multi-mode optical waveguide disposed on the substrate of the first region; an electrode wire disposed on the substrate of the second region; a heater disposed on a top surface of the first multi-mode optical waveguide; and connection wires connecting the heater to the electrode wire. The first multi-mode optical waveguide may have incline sidewalls; and the connection wires may be disposed on the incline sidewalls of the first multi-mode optical waveguide.

In some embodiments, the substrate may be a silicon substrate or a glass substrate.

In other embodiments, the optical switch device may further include: bonding wires connected to both ends of a top surface of the electrode wire.

In still other embodiments, the optical switch device may further include: an insulating layer disposed between the substrate and the electrode wire.

In yet other embodiments, the optical switch device may further include: a second multi-mode optical waveguide disposed on a top surface of the electrode wire in the second region. The second multi-mode optical waveguide may have sidewalls substantially perpendicular to a top surface of the substrate.

In yet still other embodiments, the first multi-mode optical waveguide may include a lower cladding, an upper cladding disposed on a top surface of the lower cladding, and a core disposed between the lower and the upper claddings.

In yet still other embodiments, the core may be disposed in the lower cladding; and the upper cladding may cover a top surface of the core.

In yet still other embodiments, the core may be disposed on a top surface of the lower cladding; and the upper cladding may cover the core.

In another aspect, a method of manufacturing an optical switch device may include: forming an electrode wire on a portion of a substrate; sequentially forming a lower cladding layer, a core, and an upper cladding layer on the substrate having the electrode wire; patterning the upper cladding layer and the lower cladding layer to form a first multi-mode optical waveguide having incline sidewalls, the first multi-mode optical waveguide disposed on another portion of the substrate on which the electrode wire is not disposed; forming a heater on a top surface of the first multi-mode optical waveguide; and forming connection wires on the incline sidewalls of the first multi-mode optical waveguide, the connection wires connecting the heater to the electrode wire.

In some embodiments, forming the first multi-mode optical waveguide may include: forming a photoresist pattern having incline sidewalls on a top surface of the upper cladding layer; etching the upper cladding layer and the lower cladding layer using the photoresist pattern as an etch mask; and removing the photoresist pattern.

In other embodiments, forming the photoresist pattern may include: coating a photoresist layer on the top surface of the upper cladding layer; disposing a mask structure having mask patterns over the photoresist layer, wherein distances between the mask patterns gradually increase along one direction; and irradiating ultraviolet rays toward a top surface of the mask structure. The one direction may correspond to a horizontal direction from a top end of the incline sidewall of the photoresist pattern to a bottom end of the incline sidewall of the photoresist pattern.

In still other embodiments, the substrate may include a first region and a second region; the first multi-mode optical waveguide may be formed on the substrate in the first region. In this case, patterning the upper and lower cladding layers may further include: forming a second multi-mode optical waveguide on a top surface of the electrode wire in the second region.

In yet other embodiments, sidewalls of the second multi-mode optical waveguide may be substantially perpendicular to a top surface of the substrate.

In yet still other embodiments, forming the heater may include: forming a heater layer on a top surface of the upper cladding layer.

### BRIEF DESCRIPTION OF THE DRAWINGS

The inventive concept will become more apparent in view of the attached drawings and accompanying detailed description.

FIG. 1 is a plan view illustrating an optical switch device according to some embodiments of the inventive concept;

FIG. 2 is a cross-sectional view illustrating an optical switch device according to some embodiments of the inventive concept;

FIG. 3 is a cross-sectional view illustrating an optical switch device according to other embodiments of the inventive concept;

FIGS. 4A to 4G are cross-sectional views illustrating a method of manufacturing an optical switch device according to some embodiments of the inventive concept;

FIG. 5 is a cross-sectional view illustrating a method of manufacturing an optical switch device according to other embodiments of the inventive concept;

FIG. 6 is a cross-sectional view illustrating a method of forming a photoresist pattern having an incline plane in a method of manufacturing an optical switch device according to some embodiments of the inventive concept;

FIG. 7 is a scanning electron microscope (SEM) photograph of an optical switch device according to some embodiments of the inventive concept; and

FIG. 8 is a microscope photograph of an optical switch device according to some embodiments of the inventive concept.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

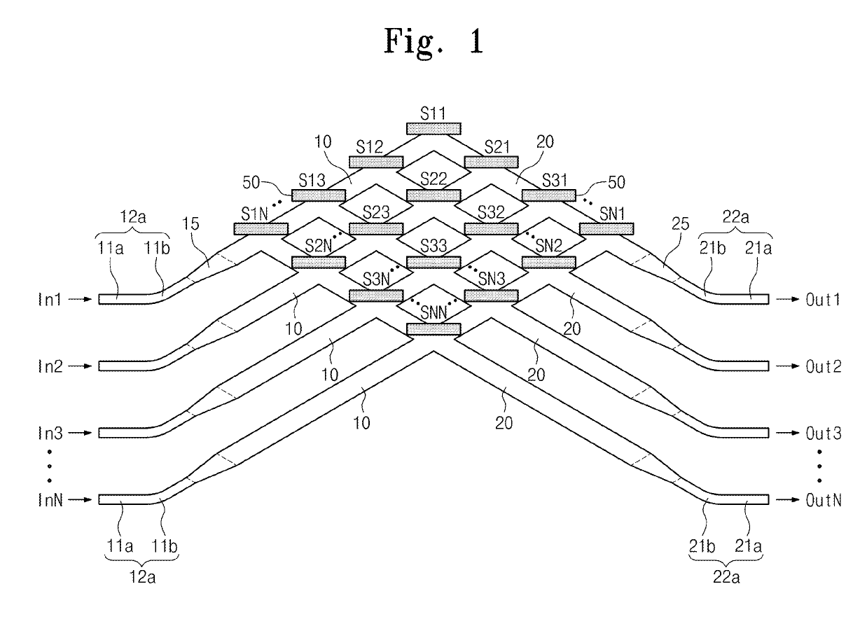

FIG. 1 is a plan view illustrating an optical switch device according to some embodiments of the inventive concept.

Referring to FIG. 1, a plurality of first multi-mode optical waveguides 10 may extend in parallel to each other in a first direction. Each of the first multi-mode optical waveguide 10 may continuously extend in the first direction. A plurality of second multi-mode optical waveguides 20 may extend in parallel to each other in a second direction different from the first direction. The plurality of second multi-mode optical waveguides 20 intersects the plurality of first multi-mode optical waveguides 10. Each of the second multi-mode optical waveguides 20 may continuously extend in the second direction. The number of the first multi-mode optical waveguides 10 may be equal to the number of the second multi-mode optical waveguides 20. Intersecting regions of the first and second multi-mode optical waveguides 10 and 20 may be two-dimensionally arranged. In other words, the intersecting regions may be two-dimensionally arranged along the first multi-mode optical waveguides 10 and the second multi-mode optical waveguides 20.

An input tapered optical waveguide 15 and an input single-mode optical waveguide 12a may be sequentially connected to an end of each of the first multi-mode optical waveguides 10. Thus, a plurality of the input single-mode optical waveguides 12a may correspond to the ends of the plurality of first multi-mode optical waveguides 10. An output tapered optical waveguide 25 and an output single-mode optical waveguide 22a may be sequentially connected to an end of each of the second multi-mode optical waveguide 20. Thus, a plurality of the output single-mode optical waveguides 22a may correspond to the ends of the plurality of second multi-mode optical waveguides 20. Each of the input single-mode optical waveguides 12a may include a first portion 11a extending in a straight line and a second portion 11b bent in a curved line. An optical signal in the second portion 11b of the input single-mode optical waveguide 12a may curvedly proceed due to the shape of the second portion 11b. Similarly, each of the output single-mode optical waveguide 22a may include a first portion 21a extending in a straight line and a second portion 21b bent in a curved line.

Heaters 50 may be disposed on the intersecting regions of the first multi-mode optical waveguides 10 and the second multi-mode optical waveguides 20. The heater 50 may be disposed in one optical switch. The optical switch may be disposed in each of the intersecting regions of the first multi-mode optical waveguides 10 and the second multi-mode optical waveguides 20. Thus, a plurality of the optical switches S11, S12, S13, . . . , S1N, S21, S22, S23, . . . , S2N, S31, S32, S33, . . . , S3N, and SN1, SN2, SN3, . . . , SNN may be arranged in N×N matrix form. The heaters 50 disposed on the intersecting regions may extend in the same direction.

The plurality of the input single-mode optical waveguides 12a may correspond to a plurality of input ports In1, In2, In3, . . . InN, respectively. The plurality of the output single-mode cores 22a may correspond to a plurality of output ports Out1, Out2, Out3, . . . , OutN, respectively. Thus, an N×N matrix optical switch may be realized by the optical switches S11, S12, S13, . . . , S1N, S21, S22, S23, . . . , S2N, S31, S32, S33, . . . , S3N, and SN1, SN2, SN3, . . . , SNN, the input ports In1, In2, In3, . . . , InN, and the output ports Out1, Out2, Out3, . . . , OutN.

A method of operating the optical switch device will be described with reference to FIG. 1. An optical signal inputted into the first input port In1 may outputted through one of the plurality of output ports Out1, Out2, Out3, . . . , OutN by controlling operations of the optical switches S11, S12, S13 . . . S1N connected to the first input port In1. Particularly, when an optical switch selected from the optical switches S11, S12, S13, . . . , S1N, S21, S22, S23, . . . , S2N, S31, S32, S33, . . . , S3N, and SN1, SN2, SN3, . . . , SNN is operated and unselected optical switches are not operated, an optical signal inputted into an input port connected to the selected optical switch may be outputted through an output port connected to the selected optical switch.

For example, when the optical switch S12 is operated and the remaining optical switches S11, S13, . . . , S1N, S21, S22, S23, . . . , S2N, S31, S32, S33, . . . , S3N, and SN1, SN2, SN3, . . . , SNN are not operated, the optical signal inputted into the first input port In1 may be outputted through a second output port Out2.

FIG. 2 is a cross-sectional view illustrating an optical switch device according to some embodiments of the inventive concept.

Referring to FIG. 2, an optical switch device may include an electrode wire 102, a first multi-mode optical waveguide 110, a heater 227, and connection wires 228. The electrode wire 102 may be disposed on a portion of a substrate 100. The first multi-mode optical waveguide 110 may be disposed on another portion of the substrate 100 on which the electrode wire 102 is not disposed. The heater 227 may be disposed on a top surface of the first multi-mode optical waveguide 110. The connection wires 228 may electrically connect the electrode wire 102 to the heater 227.

The substrate 100 may be a silicon substrate or a glass substrate. If the substrate 100 is the silicon substrate, an insulating layer 101 may be disposed on the top surface of the substrate 100 for preventing the electrode wire 102 from being electrically connected to the substrate 100. In this case, the electrode wire 102 may be disposed on the insulating layer 101. The insulating layer 101 may be formed of a silicon oxide layer.

The substrate 100 may include a first region and a second region. Another portion of the substrate 100 on which the electrode wire 102 is not disposed may be disposed in the first region.

The electrode wire 102 may have a thickness within a range of about 10 nm to about 50 nm. For example, the electrode wire 102 may include at least one of copper (Cu), gold (Au), titanium (Ti), platinum (Pt), copper-manganese (Cu/Mn), copper-aluminum (Cu/Au), Chromium-gold (Cr/Au), and titanium-platinum-gold (Ti/Pt/Au).

The first multi-mode optical waveguide 110 may be disposed the substrate 100 in the first region. The top surface of the first multi-mode optical waveguide 110 may be substantially parallel to the top surface of the substrate 100. Sidewalls of the first multi-mode optical waveguide 110 may be incline planes making an angle θ 3 equal to or greater than about 1 degree and less than about 90 degrees with the top surface of the substrate 100. The first multi-mode optical waveguide 110 may include a lower cladding 112a and an upper cladding 118a disposed on a top surface of the lower cladding 112a. The first multi-mode optical waveguide 110 may also include a core 116a in the lower cladding 112a. A top surface of the core 116a may be substantially coplanar with the top surface of the lower cladding 112a. The core 116a may be surrounded by the lower cladding 112a and the upper cladding 118a.

A second multi-mode optical waveguide 111 may be disposed on the substrate 100 in the second region. The second multi-mode optical waveguide 111 may be disposed on a top surface of the electrode wire 102. A top surface of the second multi-mode optical waveguide 111 may be substantially parallel to the top surface of the substrate 100. Sidewalls of the second multi-mode optical waveguide 111 may make an angle θ 4 of about 90 degrees with the top surface of the substrate 100. The second multi-mode optical waveguide 111 may include a lower cladding 112b and an upper cladding 118b disposed on a top surface of the lower cladding 112b. The second multi-mode optical waveguide 111 may also include a core 116a in the lower cladding 112b. A top surface of the core 116a of the second multi-mode optical waveguide 111 may be substantially coplanar with the top surface of the lower cladding 112b. The core 116a of the multi-mode optical waveguide 111 may be surrounded by the lower cladding 112b and the upper cladding 118b.

The cores 116a may correspond to paths through which light is transmitted. If the light is incident into the cores 116a from the input ports of FIG. 1 at an angle equal to or greater than a predetermined angle (a critical angle), the light is not refracted but is only reflected. The phenomenon is called total-reflection. A refractive index of a material around the core 116a must be smaller than a refractive index of the core 116a for inducing the total-reflection. In other words, each of refractive indexes of the lower claddings 112a and 112b and the upper claddings 118a and 118b must be smaller than the refractive index of each of the cores 116a. Thus, the light incident into the cores 116a may be total-reflected by the lower and upper claddings 112a, 112b, 118a and 118b, such that the light may be transmitted to the output ports of FIG. 1 through the cores 116a.

For example, the lower and upper claddings 112a, 112b, 118a, and 118b may be formed of polymer. The cores 116a may be formed of polymer.

The heater 227 may be disposed on the top surface of the first multi-mode optical waveguide 110. The connection wires 228 may be disposed on the sidewalls of the first multi-mode optical waveguide 110. The connection wires 228 may electrically connect the heater 227 to the electrode wire 102. Thus, the heater 227 may be driven by electrical connection through the electrode wire 102 and the connection wires 228. The heater 227 and the connection wires 228 may include at least one of copper (Cu), gold (Au), titanium (Ti), platinum (Pt), copper-manganese (Cu/Mn), copper-aluminum (Cu/Au), Chromium-gold (Cr/Au), and titanium-platinum-gold (Ti/Pt/Au).

The electrode wire 102 is not disposed on the top surface of the first multi-mode optical waveguide 110 but is disposed on the top surface of the substrate 100. Thus, an area of the electrode wire 102 may be reduced. As a result, a size of the optical waveguide may be reduced, such that it is possible to reduce an optical module package. Additionally, more optical waveguides may be manufactured on one chip, such that productivity may be improved.

Pads 302 may be disposed on both end portions of the electrode wire 102, and the pads 302 may be connected to bonding wires 304. The bonding wires 304 may be connected to an external power source (not shown). The pads 302 and the bonding wires 304 may include at least one of copper (Cu), gold (Au), titanium (Ti), platinum (Pt), copper-manganese (Cu/Mn), copper-aluminum (Cu/Au), Chromium-gold (Cr/Au), and titanium-platinum-gold (Ti/Pt/Au).

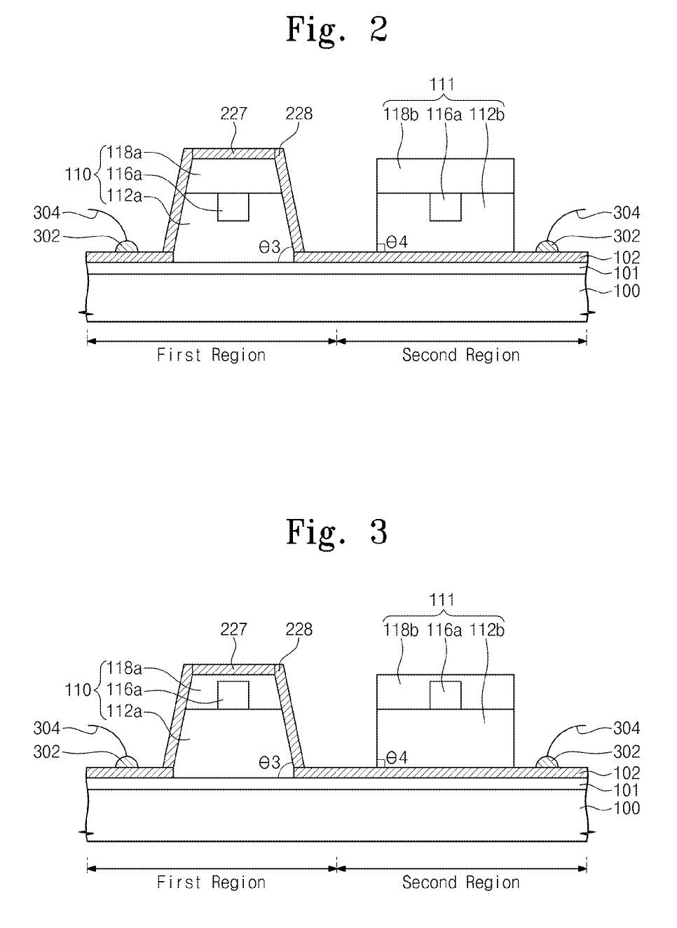

FIG. 3 is a cross-sectional view illustrating an optical switch device according to other embodiments of the inventive concept.

Referring to FIG. 3, an electrode wire 102 may be disposed on a portion of a substrate 100. The substrate 100 may include a first region and a second region. Another portion of the substrate 100 on which the electrode wire 102 is not disposed may be disposed in the first region.

The substrate 100 may be a silicon substrate or a glass substrate. If the substrate 100 is the silicon substrate, an insulating layer 101 may be disposed on the top surface of the substrate 100 for preventing the electrode wire 102 from being electrically connected to the substrate 100. In this case, the electrode wire 102 may be disposed on the insulating layer 101. The insulating layer 101 may be formed of a silicon oxide layer.

The electrode wire 102 may have a thickness within a range of about 10 nm to about 50 nm. For example, the electrode wire 102 may include at least one of copper (Cu), gold (Au), titanium (Ti), platinum (Pt), copper-manganese (Cu/Mn), copper-aluminum (Cu/Au), Chromium-gold (Cr/Au), and titanium-platinum-gold (Ti/Pt/Au).

The first multi-mode optical waveguide 110 may be disposed the substrate 100 in the first region. The first multi-mode optical waveguide 110 may include a lower cladding 112a and an upper cladding 118a disposed on a top surface of the lower cladding 112a. The first multi-mode optical waveguide 110 may also include a core 116a in the upper cladding 118a. A bottom surface of the core 116a may be substantially coplanar with a bottom surface of the upper cladding 118a. The core 116a may be surrounded by the lower cladding 112a and the upper cladding 118a.

The top surface of the first multi-mode optical waveguide 110 may be substantially parallel to the top surface of the substrate 100. Sidewalls of the first multi-mode optical waveguide 110 may be incline planes making an angle θ 3 equal to or greater than about 1 degree and less than about 90 degrees with the top surface of the substrate 100.

A second multi-mode optical waveguide 111 may be disposed on the substrate 100 in the second region. The second multi-mode optical waveguide 111 may be disposed on a top surface of the electrode wire 102. The second multi-mode optical waveguide 111 may include a lower cladding 112b and an upper cladding 118b disposed on a top surface of the lower cladding 112b. The second multi-mode optical waveguide 111 may also include a core 116a in the upper cladding 118b.

A top surface of the second multi-mode optical waveguide 111 may be substantially parallel to the top surface of the substrate 100. Sidewalls of the second multi-mode optical waveguide 111 may make an angle θ 4 of about 90 degrees (i.e., a substantially right-angle) with the top surface of the substrate 100.

For example, the lower and upper claddings 112a, 112b, 118a, and 118b may be formed of polymer. The cores 116a may be formed of silicon or polymer.

The heater 227 may be disposed on the top surface of the first multi-mode optical waveguide 110. The connection wires 228 may be disposed on the sidewalls of the first multi-mode optical waveguide 110. The connection wires 228 may electrically connect the heater 227 to the electrode wire 102. The heater 227 and the connection wires 228 may include at least one of copper (Cu), gold (Au), titanium (Ti), platinum (Pt), copper-manganese (Cu/Mn), copper-aluminum (Cu/Au), Chromium-gold (Cr/Au), and titanium-platinum-gold (Ti/Pt/Au).

The optical switch device may include pads 302 disposed on both end portions of the electrode wire 102 and bonding wires 304 connected to the pads 302.

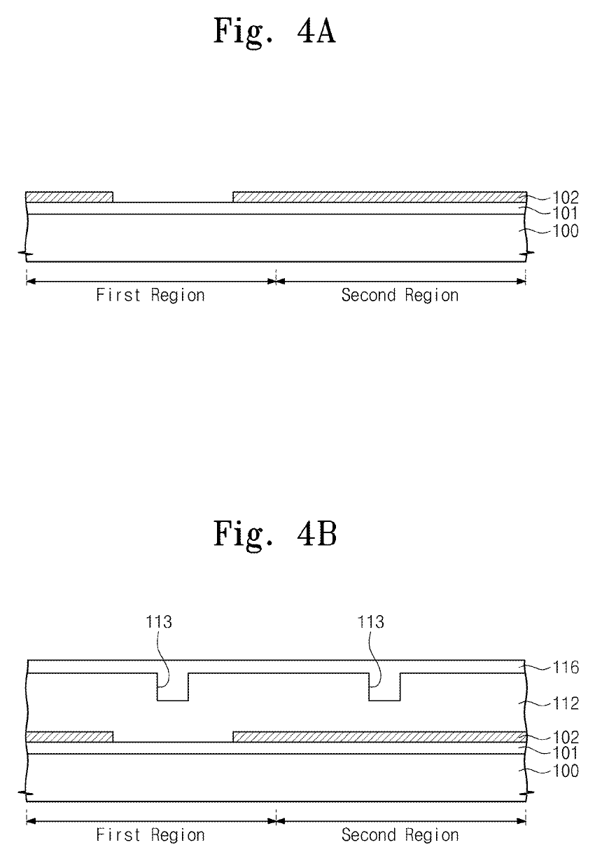

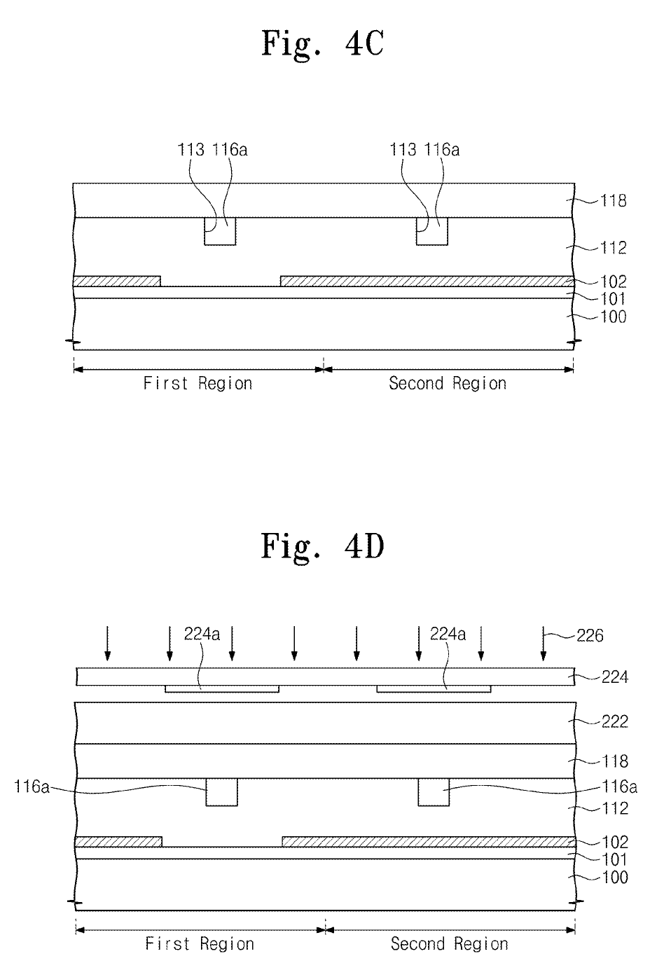

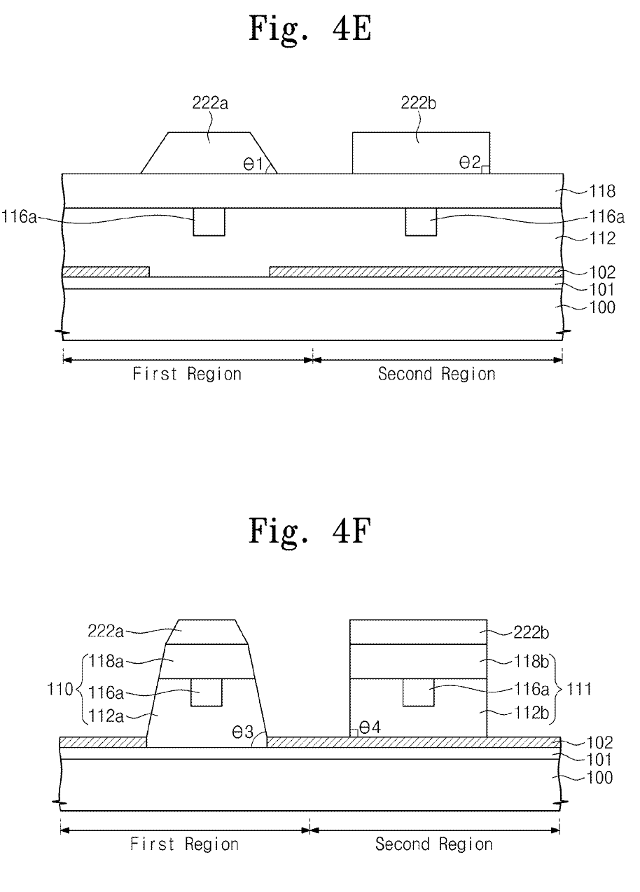

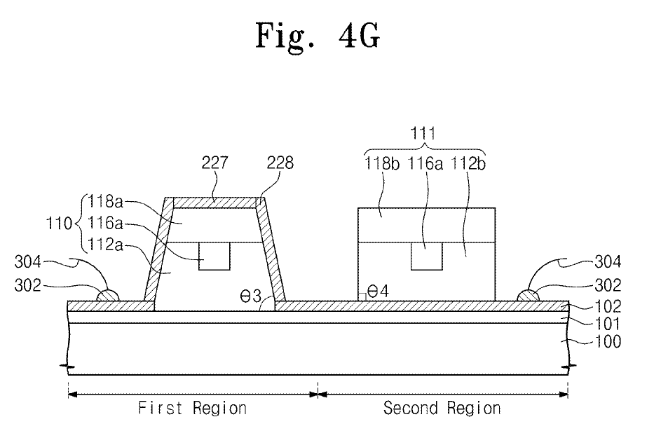

FIGS. 4A to 4G are cross-sectional views illustrating a method of manufacturing an optical switch device according to some embodiments of the inventive concept.

Referring to FIG. 4A, a substrate 100 is prepared. The substrate 100 may be a silicon substrate or a glass substrate. The substrate 100 may include a first region and a second region. An electrode wire 102 may be formed on a portion of the substrate 100. The electrode wire 102 may not be formed on a portion of the substrate 100 in the first region.

The electrode wire 102 may be formed by one of a thermal evaporation deposition process, an e-beam evaporation deposition process, and a sputtering deposition process. The electrode wire 102 may be formed to have a thickness within a range of about 10 nm to about 50 nm. A portion of the electrode wire 102 in the first region may be removed by one of a lift-off process, a wet etching process, and a dry etching process. For example, the electrode wire 102 may be formed of at least one of copper (Cu), gold (Au), titanium (Ti), platinum (Pt), copper-manganese (Cu/Mn), copper-aluminum (Cu/Au), Chromium-gold (Cr/Au), and titanium-platinum-gold (Ti/Pt/Au).

If the substrate 100 is a silicon substrate, an insulating layer 101 may be disposed on the top surface of the silicon substrate for preventing the electrode wire 102 from being electrically connected to the substrate 100 before the electrode wire 102 is formed. The insulating layer 101 may be a silicon oxide layer which is naturally formed when the silicon substrate is exposed in the atmosphere.

Referring to FIG. 4B, a lower cladding layer 112 may be formed on the substrate 100 having the electrode wire 102 and then trenches 113 may be formed in the lower cladding layer 112. A core layer 116 filling the trenches 113 may be formed on the lower cladding layer 112.

The lower cladding layer 112 may be formed by a spin coating method. The lower cladding layer 112 may be formed of polymer.

The trenches 113 may be formed by a photolithography process and an etching process. The etching process for the formation of the trenches 113 may be performed by a dry etching process such as a reactive ion etching (RIE) process or an inductively coupled plasma (ICP) etching process. The trenches 113 may be formed by etching portions of the lower cladding layer 112.

The core layer 116 may be formed on the lower cladding layer 112 by a spin coating method. The core layer 116 may fill the trenches 113. The core layer 116 may be formed of a polymer layer.

Referring to FIG. 4C, the core layer 116 outside the trenches 113 may be removed to form cores 116a in the trenches 113, respectively. The core layer 116 outside the trenches 113 may be removed by a dry etching process such as a RIE process or an ICP etching process, thereby exposing a top surface of the lower cladding layer 112.

The core layer 116 may be planarized by one deposition process and one etching process. However, the inventive concept is not limited thereto. An additional deposition process and an additional etching process may be repeatedly performed to planarize the core layer 116 if needed.

An upper cladding layer 118 may be formed on the top surface of the lower cladding layer 112 in which the cores 116a are formed. The upper cladding layer 118 may be formed by a spin coating method. The upper cladding layer 118 may be formed of polymer. The lower cladding layer 112 may be formed of the same material as the upper cladding layer 118. A refractive index of the cores 116a may be greater than those of the lower and upper cladding layers 112 and 118.

Referring to FIG. 4D, a photoresist layer 222 may be formed on the upper cladding layer 118. The photoresist layer 222 may be formed by a spin coating method.

A mask structure 224 may be disposed over the photoresist layer 222 and then a photolithography process may be performed. The photoresist layer 222 may be patterned in various shapes by controlling the amount of ultraviolet rays 226 passing through the mask structure 224. The mask structure 224 may include mask patterns 224a. Thus, the photoresist layer 222 may be partially exposed due to the ultraviolet rays 226 passing between the mask patterns 224a. The portions exposed by the ultraviolet rays 226 of the photoresist layer 222 may be removed by a developing process.

Referring to FIG. 4E, the photoresist layer 222 may be pattered, as described above, to form a first photoresist pattern 222a and a second photoresist pattern 222b. The first and second photoresist patterns 222a and 222b may be formed over the cores 116a, respectively.

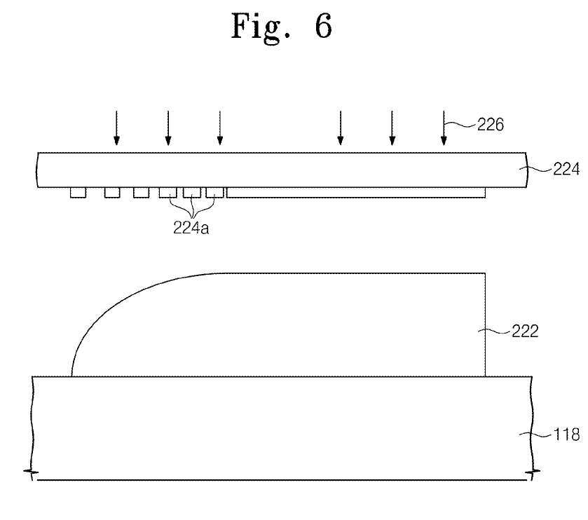

A top surface of the first photoresist pattern 222a may be substantially parallel to a top surface of the upper cladding layer 118. Sidewalls of the first photoresist pattern 222a may make a first angle θ 1 equal to or greater than about 1 degree and less than about 90 degrees with the top surface of the upper cladding layer 118. The top surface of the first photoresist pattern 222a may not be exposed by the ultraviolet rays 226 and may not be removed. The amount of the ultraviolet rays 226 passing through the mask structure 224 may gradually increase to form the first photoresist pattern 222a including the sidewalls of the first angle θ 1. To achieve this, a gray tone mask may be used. This will be described in more detail with reference to FIG. 6 later.

In other embodiments, the photoresist layer 222 may be patterned using a general photo mask structure. A reflow process may be performed on the patterned photoresist layer 222 at a temperature within a range of about 100 degrees Celsius to about 120 degrees Celsius, thereby forming the first photoresist pattern 222a having the first angle θ 1.

Referring to FIG. 4F, a first multi-mode optical waveguide 110 and a second multi-mode optical waveguide 111 may be formed using the first and second photoresist patterns 222a and 222b as etch masks.

The first and second photoresist patterns 222a and 222b may also be etched while the upper and lower cladding layers 118 and 112 are etched.

The upper and lower cladding layers 118 and 112 may be etched by a dry etching process. For example, the dry etching process may be a RIE process or a ICP etching process.

Sidewalls of the first multi-mode optical waveguide 110 formed using the first photoresist pattern 222a may make a third angle θ 3 equal to or greater than about 1 degree and less than about 90 degrees with the top surface of the substrate 100. The first multi-mode optical waveguide 110 may be formed on the portion of the substrate 100 on which the electrode wire 102 is not formed. In other words, the first multi-mode optical waveguide 110 may be formed on the substrate 100 in the first region.

Sidewalls of the second multi-mode optical waveguide 111 formed using the second photoresist pattern 222b may have a fourth angle θ 4 substantially perpendicular to the top surface of the substrate 100. The second multi-mode optical waveguide 111 may be formed on the top surface of the electrode wire 102. In other words, the second multi-mode optical waveguide 111 may be formed over the substrate 100 in the second region.

Referring to FIG. 4G, the first and second photoresist patterns 222a and 222b may be removed. The first and second photoresist patterns 222a and 222b may be removed by a wet etching process or a dry etching process.

A heater 227 may be formed on a top surface of the first multi-mode optical waveguide 110. Connection wires 228 may be formed on the sidewalls of the first multi-mode optical waveguide 110. The connection wires 228 may electrically connect the heater 227 to the electrode wire 102. Pads may be formed on the electrode wire 102. The pads 302 may be connected to bonding wires 304.

The heater 227 and the connection wires 228 may be formed by one of a thermal evaporation deposition method, an e-beam evaporation deposition method, and a sputtering deposition method.

For example, the heater 227 and the connection wires 228 may be formed of at least one of copper (Cu), gold (Au), titanium (Ti), platinum (Pt), copper-manganese (Cu/Mn), copper-aluminum (Cu/Au), Chromium-gold (Cr/Au), and titanium-platinum-gold (Ti/Pt/Au).

A wire bonding process forming the pads 302 and the bonding wires 304 may be performed on the top surface of the electrode wire 102. Thus, it is possible to prevent physical and thermal damages of the optical waveguide which are caused by performing a bonding process on the first multi-mode optical waveguide. Additionally, it is possible to reduce bonding errors of the bonding process performed on the electrode wire 102 as compared with a bonding process performed on the top surface of the first multi-mode optical waveguide 110.

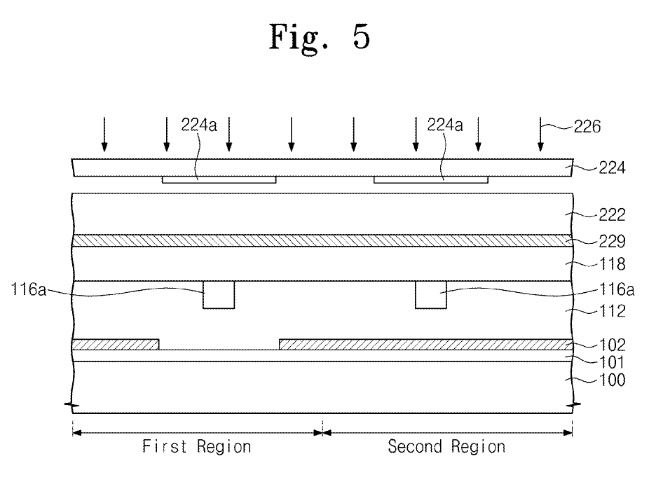

FIG. 5 is a cross-sectional view illustrating a method of manufacturing an optical switch device according to other embodiments of the inventive concept.

Referring to FIG. 5, a heater layer 229 may be formed on the top surface of the upper cladding layer 118 before the photoresist layer 222 is formed. In this case, the photoresist layer 222 may be formed on the heater layer 229 and then the photoresist layer 222 may be patterned to form the first and second photoresist patterns 222a and 222b of FIG. 4E. In this case, the heater 227 of FIG. 4G may be formed of a portion of the heater layer 229.

FIG. 6 is a cross-sectional view illustrating a method of forming a photoresist pattern having an incline plane in a method of manufacturing an optical switch device according to some embodiments of the inventive concept.

Referring to FIG. 6, the photoresist layer 222 may be formed on the top surface of the upper cladding layer 118 and then the mask structure 224 may be disposed over the photoresist layer 222.

The mask structure 224 may include mask patterns 224a. For performing an exposure process, the ultraviolet rays 226 may be irradiated to a top surface of the mask structure 224. Thus, the photoresist layer 224 may be exposed by the ultraviolet rays 226 passing through spaces between the mask patterns 224a.

Distances between the mask patterns 224a may gradually increase along one direction. The one direction may correspond to a horizontal direction from a top end of an incline sidewall of a patterned photoresist layer 222 to a bottom end of the incline sidewall. As the distances between mask patterns 224a may gradually increase, the amount of the ultraviolet rays 226 passing between the mask patterns 224a may gradually increase. Thus, a removed amount of the photoresist layer 222 may be proportional to the amount of the ultraviolet rays 226 supplying to the photoresist layer 222 during a developing process. As a result, the patterned photoresist layer 222 may have the incline sidewall.

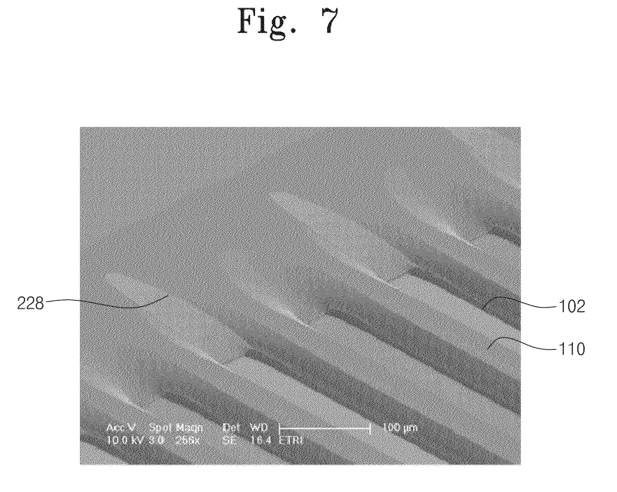

FIG. 7 is a scanning electron microscope (SEM) photograph of an optical switch device according to some embodiments of the inventive concept.

Referring to FIG. 7, the first multi-mode optical waveguide 110 is formed on the top surface of the electrode wire 102. The electrode wire 102 is connected to the connection wires 228. The connection wires 228 are formed on the incline sidewalls.

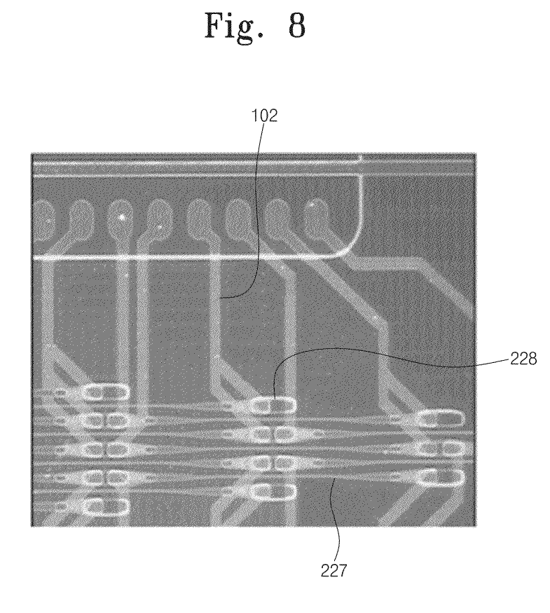

FIG. 8 is a microscope photograph of an optical switch device according to some embodiments of the inventive concept.

Referring to FIG. 8, the connection wire 228 connects the electrode wire 102 to the heater 227.

According to embodiments of the inventive concept, the optical switch device may include the electrode wire disposed on a portion of the substrate and the first multi-mode optical waveguide disposed on another portion of the substrate where the electrode wire is not disposed. The heater is disposed on the top surface of the first multi-mode optical waveguide and the connection wires are disposed on the sidewalls of the first multi-mode optical waveguide. The connection wires electrically connect the heat to the electrode wire. The wire area may be reduced by the electrode wire formed on the top surface of the substrate. Thus, degree of freedom for wire-design may be improved and the size of the optical waveguide may be reduced.

Additionally, in the method of manufacturing the optical switch device according to embodiments of the inventive concept, the pads may be formed on the top surface of the electrode wire and the wire bonding process may be formed for connecting the pads and the bonding wires. The wire bonding process may involve heat and pressure. Thus, if the wire bonding process is performed on a material (e.g., polymer or an organic material) weak to the heat and the pressure, a property and/or a shape of the material may be transformed. However, according to embodiments of the inventive concept, since the wire bonding process is performed on the top surface of the electrode wire, the first multi-mode optical waveguide does not suffer from physical and thermal stresses. Thus, it is possible to reduce or prevent a crack and/or polarization dependent loss of the first multi-mode optical waveguide which may be caused by the physical and thermal stresses such as the heat and the pressure.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. An optical switch device comprising:
a substrate including a first region and a second region;
a first multi-mode optical waveguide disposed on the substrate of the first region;
an electrode wire disposed on the substrate of the second region;
a heater disposed on a top surface of the first multi-mode optical waveguide; and
connection wires connecting the heater to the electrode wire,
wherein the first multi-mode optical waveguide has incline sidewalls; and
wherein the connection wires are disposed on the incline sidewalls of the first multi-mode optical waveguide.

2. The optical switch device of claim 1, wherein the substrate is a silicon substrate or a glass substrate.

3. The optical switch device of claim 1, further comprising:
bonding wires connected to both ends of a top surface of the electrode wire.

4. The optical switch device of claim 1, further comprising:
an insulating layer disposed between the substrate and the electrode wire.

5. The optical switch device of claim 1, further comprising:
a second multi-mode optical waveguide disposed on a top surface of the electrode wire in the second region,
wherein the second multi-mode optical waveguide has sidewalls substantially perpendicular to a top surface of the substrate.

6. The optical switch device of claim 1, wherein the first multi-mode optical waveguide includes a lower cladding, an upper cladding disposed on a top surface of the lower cladding, and a core disposed between the lower and the upper claddings.

7. The optical switch device of claim 6, wherein the core is disposed in the lower cladding; and
wherein the upper cladding covers a top surface of the core.

8. The optical switch device of claim 6, wherein the core is disposed on a top surface of the lower cladding; and
wherein the upper cladding covers the core.

9. A method of manufacturing an optical switch device, comprising:
forming an electrode wire on a portion of a substrate;
sequentially forming a lower cladding layer, a core, and an upper cladding layer on the substrate having the electrode wire;
patterning the upper cladding layer and the lower cladding layer to form a first multi-mode optical waveguide having incline sidewalls, the first multi-mode optical waveguide disposed on another portion of the substrate on which the electrode wire is not disposed;
forming a heater on a top surface of the first multi-mode optical waveguide; and
forming connection wires on the incline sidewalls of the first multi-mode optical waveguide, the connection wires connecting the heater to the electrode wire.

10. The method of claim 9, wherein forming the first multi-mode optical waveguide comprises:
forming a photoresist pattern having incline sidewalls on a top surface of the upper cladding layer;
etching the upper cladding layer and the lower cladding layer using the photoresist pattern as an etch mask; and
removing the photoresist pattern.

11. The method of claim 10, wherein forming the photoresist pattern comprises:
coating a photoresist layer on the top surface of the upper cladding layer;
disposing a mask structure having mask patterns over the photoresist layer, wherein distances between the mask patterns gradually increase along one direction; and
irradiating ultraviolet rays toward a top surface of the mask structure,
wherein the one direction corresponds to a horizontal direction from a top end of the incline sidewall of the photoresist pattern to a bottom end of the incline sidewall of the photoresist pattern.

12. The method of claim 9, wherein the substrate includes a first region and a second region;
wherein the first multi-mode optical waveguide is formed on the substrate in the first region; and
wherein patterning the upper and lower cladding layers further comprises:
forming a second multi-mode optical waveguide on a top surface of the electrode wire in the second region.

13. The method of claim 12, wherein sidewalls of the second multi-mode optical waveguide are substantially perpendicular to a top surface of the substrate.

14. The method of claim 9, wherein forming the heater comprises:
forming a heater layer on a top surface of the upper cladding layer.
